(19) United States
(12) Patent Application Publication
(10) Pub. No.: US 2003/0007149 A1
(43) Pub. Date: Jan. 9, 2003

(54) Depolarizer and spectroscope

(75) Inventors: Toshikazu Yamamoto, Tokyo (JP); Tsutomu Kaneko, Tokyo (JP)

Correspondence Address: OLIFF & BERRIDGE, PLC, P.O. BOX 19928, ALEXANDRIA, VA, 22320, US

(73) Assignee: Ando Electric Co., Ltd., Tokyo (JP)

(21) Appl. No.: 10/164,579

(22) Filed: Jun. 10, 2002

(30) Foreign Application Priority Data
Jun. 28, 2001 (JP) 2001-196745

(51) Int. Cl. G01J 3/18

(52) U.S. Cl. 356/328

(57) ABSTRACT

A spectroscope having a high spectroscopic characteristic capable of eliminating a polarization dependence on an arbitrary polarization state of an incident light, and measuring a spectrum having a true central wavelength of the light. The spectroscope comprises: a depolarizer comprising: a first plate a thickness of which continuously changes in a direction of 45 degrees with a first optical axis; and a second plate a thickness of which continuously changes, and which is stuck on the first plate; wherein an angle between the first optical axis and a second optical axis of the second plate, is 45 degrees, and a first reduction direction of the thickness of the first plate and a second reduction direction of the thickness of the second plate is opposite to each other; and a spectroscopic device a dispersion direction of which intersects orthogonally with the first reduction direction.

### BACKGROUND OF THE INVENTION

1. Field of the Invention

The present invention relates to a depolarizer used for eliminating a polarization dependence of a spectroscope.

2. Description of Related Art

In general, a dispersion device used in a spectroscope has a polarization dependence. When such a light polarized in a particular direction, as a linearly polarized light, is incident on the dispersion device, even if the incident light has a given energy, the dispersion device has a particular output characteristics in accordance with the direction in which the incident light is polarized. A diffraction grating is a representative example of the dispersion device which is used in the spectroscope. The diffraction grating has the polarization dependence that is a diffraction efficiency varies with a polarization state of the incident light. In other words, a reflectance with the polarized light component perpendicular to a groove cut in the diffraction grating and a reflectance with the polarized light component parallel to the groove, are different from each other. Therefore, because the diffraction efficiency varies according to the polarization state of the incident light in the spectroscope using the diffraction grating, a trouble occurs on measuring a spectroscopic characteristic of the incident light. In order to remove such a polarization dependence, it is necessary to provide a polarization scrambler which converts the incident light in the arbitrary polarization state, into a circular polarized light or no polarized light.

A depolarizer is used as the polarization scrambler. An example of a depolarizer according to an earlier development, for example, as disclosed in Patent No. 2,995,985, will be explained with reference to FIG. 4.

In FIG. 4, a reference numeral 2 denotes a depolarizer. Reference numerals 2a and 2b denote crystal plates, respectively. The crystal plate 2a has a thickness which continuously changes in a direction of 45 deg. with an optical axis thereof. Further, the crystal plate 2b has a thickness which continuously changes in a direction of 45 deg. with an optical axis thereof. A reference numeral 21 denotes the optical axis of the crystal plate 2a. Further, a reference numeral 22 denotes the optical axis of the crystal plate 2b. The crystal plate 2a and the crystal plate 2b have similar shapes to each other. The depolarizer 2 is constituted by sticking the crystal plate 2a and the crystal plate 2b so that the optical axis 21 and the optical axis 22 intersects orthogonally with each other.

Next, an operation of the depolarizer 2 shown in FIG. 4 will be explained with reference to FIG. 5. FIG. 5 is a side view of the depolarizer 2.

A crystal has an optical axis extending to a particular direction on the basis of a crystalline structure. When a light enters the crystal, the light is separated to a plane light parallel to the optical axis and a plane light perpendicular to the optical axis. Then, the plane lights travel in the crystal at phase speeds which are different from each other, respectively. This phenomenon will be called a birefringence. In other words, the crystal has the birefringence which causes a phase difference between a light component oscillating in a direction parallel to the optical axis and a light component oscillating in a direction perpendicular to the optical axis, of the light which passes through the crystal. The phase difference caused in the crystal is proportional to the thickness of the crystal. Because the thickness of each of the crystal plates 2a and 2b varies continuously, the thickness of each of the crystal plates 2a and 2b is different according to a point through which the light passes. As a result, the phase difference is different according to the point through which the light passes.

More particularly, even if the polarization states of lights L1, L2 and L3 shown in FIG. 5 are equal to each other before the lights L1, L2 and L3 pass through the crystal plates 2a and 2b, because the phase differences which are caused to the lights L1, L2 and L3 in the crystal plates 2a and 2b are different from each other, the polarization states of the lights L1, L2 and L3 are different from each other after the lights L1, L2 and L3 pass through the crystal plates 2a and 2b. Therefore, it is possible that the depolarizer 2 converts the polarization state of the light to the state wherein a large number of polarization states are mixed with respect to a space. In other words, the depolarizer 2 disturbs the polarization states of the lights with respect to a space. However, the depolarizer 2 does not have an effect with respect to the incident light which oscillates in the direction parallel or perpendicular to the optical axis. As a result, such an incident light passes through the depolarizer 2 with keeping the polarization state before the incident light enters the depolarizer 2.

Next, an example of the depolarizer 2 to be used will be explained with reference to FIG. 14. FIG. 14 is a view showing a configuration of a spectroscope which uses the depolarizer 2.

In FIG. 14, a reference numeral 3 denotes an incident slit, 4 denotes a concave mirror, 5 denotes a diffraction grating, 6 denotes a concave mirror, and 7a denotes an outgoing slit. The depolarizer 2 is positioned after the incident slit 3 so as to direct the optical axis thereof in a direction of 45 deg. with grooves of the diffraction grating 5.

The depolarizer 2 makes the incident light have the state wherein a large number of polarization states are mixed. When the incident light oscillating in the direction parallel or perpendicular to the optical axis of the depolarizer 2, is incident on the depolarizer 2, the incident light passes through the depolarizer 2 with keeping the polarization state before the light enters the depolarizer 2. After the incident light passes through the depolarizer 2, the incident light enters the diffraction grating 5 with the angle of 45 deg. with grooves of the diffraction grating 5. Therefore, even if the incident light is incident on the depolarizer 2 in any polarization state, the incident light is incident on the diffraction grating 5 in an always constant ratio between the light component oscillating in the direction perpendicular to the grooves of the diffraction grating 5 and the light component oscillating in the direction parallel to the grooves. As a result, the diffraction efficiency does not vary in the spectroscope according to the polarization state of the incident light.

Next, problems according to an earlier development will be explained with reference to FIG. 11. FIG. 11 is a side view of the depolarizer 2.

Because the optical axis of the crystal plate 2a and the optical axis of the crystal plate 2b intersect orthogonally with each other, the light which is parallel to the optical axis of the crystal plate 2a is perpendicular to the optical axis of the crystal plate 2b. Therefore, because refractive indexes are different from each other at both sides of the inclined surface between the crystal plates 2a and 2b, the light is refracted on the inclined surface. Furthermore, a refraction angle to the light component oscillating in the direction parallel to the optical axis 21 of the crystal plate 2a and a refraction angle to the light component oscillating in the direction perpendicular to the optical axis 21 are different from each other.

More specifically, a light component of an incident light L4 shown in FIG. 11, oscillating in the direction parallel to the optical axis 21 becomes a refracted light L5. Further, a light component of the incident light L4, oscillating in the direction perpendicular to the optical axis 21 becomes a refracted light L6. In other wards, there is a problem in which the incident light is separated into two light rays along the direction of the inclined surfaces in depolarizer 2.

Accordingly, in also FIG. 14, the light is separated into two light rays in the depolarizer 2. As a result, two focal point positions are formed on the outgoing slit 7a.

FIG. 6 is a front view of the outgoing slit 7a shown in FIG. 14. In FIG. 6, a reference mark F2 denotes a focal point position in case the depolarizer 2 is not provided in the spectroscope. Reference marks F1 and F3 denote focal point positions in case the depolarizer 2 is provided in the spectroscope.

$$\begin{matrix}{E}_{0} = \frac{1}{\sqrt{2}} ( \begin{matrix}cos φ & - sin φ \\ sin φ & cos φ\end{matrix} ) ( \begin{matrix}exp ( \frac{- i δ}{2} ) \\ exp ( \frac{δ}{2} )\end{matrix} ) exp [ i ( 2 π ft - {δ}_{0} ) ] & Eq . 1 \\ {P}_{θ} = ( \begin{matrix}{cos}^{2} θ & cos θ \cdot sin θ \\ cos θ \cdot sin θ & {sin}^{2} θ\end{matrix} ) & Eq . 2 \\ G = ( \begin{matrix}α & 0 \\ 0 & β\end{matrix} ) & Eq . 3 \\ {E}_{1} = G \cdot {P}_{45 °} \cdot {E}_{0} = \frac{1}{\sqrt{2}} ( cos φ \cdot cos \frac{δ}{2} - i \cdot sin φ \cdot sin \frac{δ}{2} ) ( \begin{matrix}α \\ β\end{matrix} ) exp [ i ( 2 π ft - {δ}_{0} ) ] & Eq . 4 \\ {E}_{2} = G \cdot {P}_{- 45 °} \cdot {E}_{0} = \frac{1}{\sqrt{2}} ( sin φ \cdot cos \frac{δ}{2} + i \cdot cos φ \cdot sin \frac{δ}{2} ) ( \begin{matrix}- α \\ β\end{matrix} ) exp [ i ( 2 π ft - {δ}_{0} ) ] & Eq . 5 \\ {P}_{1} = {E}_{1} \cdot {E}_{1}^{*} = \frac{1}{2} ( {cos}^{2} φ \cdot {cos}^{2} \frac{δ}{2} + {sin}^{2} φ \cdot {sin}^{2} \frac{δ}{2} ) ( {α}^{2} + {β}^{2} ) & Eq . 6 \\ {P}_{2} = {E}_{2} \cdot {E}_{2}^{*} = \frac{1}{2} ( {sin}^{2} φ \cdot {cos}^{2} \frac{δ}{2} + {cos}^{2} φ \cdot {sin}^{2} \frac{δ}{2} ) ( {α}^{2} + {β}^{2} ) & Eq . 7 \\ P = {P}_{1} + {P}_{2} = \frac{1}{2} ( {α}^{2} + {β}^{2} ) & Eq . 8\end{matrix}$$

Power of each of the light ray which has the focal point F1 and the light ray which has the focal point F3 varies according to the polarization state of the incident light. Using Jones vector notation representative of the polarization state of the light, it is possible to express an incident light E₀ in an arbitrary completely polarization state as shown in Equation (1). A first component of Equation (1) represents a scalar value of a X directional component, and a second component of Equation (1) represents a scalar value of a Y directional component. In Equation (1), “f” represents a frequency, “δ₀” represents an initial phase, “δ” represents a phase difference between the X directional component and the Y directional component, and “φ” represents an azimuth angle.

When the incident light represented by Equation (1) passes through the depolarizer 2 shown in FIG. 14, the incident light is separated into two light rays L5 and L6. Then, the light rays L5 and L6 pass through the diffraction grating 5. Two light rays which have passed through the diffraction grating 5 come into two focal points F1 and F3 on the outgoing slit 7a as shown in FIG. 6, respectively.

In FIG. 6, “E1” of Equation (4) represents the state of the light ray at the focal point F1, and “P1” of Equation (6) represents the power of the light ray at the focal point F1. “E2” of Equation (5) represents the state of the light ray at the focal point F3, and “P2” of Equation (7) represents the power of the light ray at the focal point F3. “P_{θ}” of Equation (2) represents a partial polarizer of an azimuth angle θ. “G” of Equation (3) represents a diffraction grating whose diffraction efficiency of the X directional component is equal to α and whose diffractive efficiency of the Y directional component is equal to β. “*” represents a complex conjugate in each of Equations (6) and (7). As readily understood from Equation (8), a total intensity of the light rays at two focal points F1 and F3 is constant regardless of the state of the incident light E₀. However, as readily understood from Equations (6) and (7), an intensity ratio between the light ray at the focal point F1 and the light ray at the focal point F3 varies in accordance with the state of the incident light E₀.

In the spectroscope shown in FIG. 14, the two light rays into which the light passing through the depolarizer 2 is separated, is reflected on the concave mirror 4 and diffracted by the diffraction grating 5. Equation (0) represents a relationship between an incident angle and a diffraction angle of the diffraction grating 5.

mλ=d cos ξ(sin ψ₁+sin ψ₂) Eq.0

In Equation (0), “m” represents the diffraction order, “d” represents a grating constant of the diffraction grating 5, “λ” represents a wavelength of the light, “ξ” represents an angle between the incident light and a surface perpendicular to grating grooves of the diffraction grating 5, “ψ₁” represents an incident angle of the incident light on the diffraction grating 5, and “ψ₂” represents a diffraction angle of the diffracted light by the diffraction grating 5.

FIG. 15 is a view showing a relationship of the angle ξ, the incident angle ψ₁, and the diffraction angle ψ₂. Under restriction of positions of the parts, there is a case that the light is reflected with deviating from an axis of the concave mirror 4, and inputted to the diffraction grating 5 so as to be inclined in the Y axis direction. When the two refracted lights L5 and L6 enter the diffraction grating 5, the refracted lights L5 and L6 are incident on the diffraction grating 5 with the same incident angles ψ₁ with each other but the different angles ξ from each other, in Equation (0). Therefore, as readily understood from Equation (0), because the two lights are outputted from the diffraction grating 5 with the different diffraction angles ψ₂ from each other, there occurs displacement in two lights in X axis direction shown in each of FIGS. 14 and 15. As a result, as shown in FIG. 7, two focal points F4 and F5 are formed in a slanting direction with the cutting direction of the outgoing slit 7a. In other words, the focal points F4 and F5 are provided at the different positions in the direction perpendicular to the cutting direction of the outgoing slit 7a.

As described above, if the focal points F4 and F5 are provided at the different positions in the direction perpendicular to the cutting direction of the outgoing slit 7a, and as explained with reference to Equations (6) and (7), the intensity ratio between the light rays at the two focal points F4 and F5 varies in accordance with the state of the incident light, the spectroscope outputs a measured central wavelength which is different from a true central wavelength.

FIGS. 13A to 13C are views showing spectrum waveforms which are outputted to a spectrum display unit 10 shown in FIG. 14. FIG. 13A is a view showing a measured spectrum in case the light is not separated, and one focal point is formed on the outgoing slit 7a. FIG. 13B is a view showing a measured spectrum in case the intensity ratio between the light rays at the two focal points F4 and F5 shown in FIG. 7 is equal to 1:0. FIG. 13C is a view showing a measured spectrum in case the intensity ratio between the light rays at the two focal points F4 and F5 shown in FIG. 7 is equal to 0:1. In FIGS. 13A to 13C, “λ₀” represents a true central wavelength of the incident light, and “αλ” represents a difference between the true central wavelength and the measured central wavelength. The measured spectrum obtained by the spectroscope using the depolarizer 2 varies from the state shown in FIG. 13B to the state shown in FIG. 13C, in accordance with the polarization state of the light. As a result, it is difficult to measure the true central wavelength of the light.

If any one of the powers of the light rays at the focal points F4 and F5 of the outgoing slit 7a shown in FIG. 7, concerning the incident light in the arbitrary polarization state is always zero, and the other of the powers is always constant, it is possible to obtain the spectrum having a stable central wavelength concerning the incident light in the arbitrary polarization state. For example, if it is possible to always obtain the state shown in FIG. 13B, it is possible to measure the spectrum having the true central wavelength by an adjusting function of subtracting the constant αλ from the measured central wavelength.

### SUMMARY OF THE INVENTION

The present invention was developed in view of the above-described problems.

It is an object of the present invention to realize a spectroscope having a high spectroscopic characteristic that is capable of eliminating a polarization dependence of a spectroscopic device, on an arbitrary polarization state of an incident light, and measuring a spectrum having a true central wavelength of the light. It is another object of the present invention to provide a depolarizer capable of realizing the above-described spectroscope.

In order to attain the above-described objects, in accordance with an aspect of the present invention, a depolarizer (for example, a depolarizer 1) comprises: a first plate (1b) a thickness of which continuously changes in a direction of 45 degrees with a first optical axis (12) of the first plate; and a second plate (1c) a thickness of which continuously changes, and which is stuck on the first plate; wherein an angle between the first optical axis (12) of the first plate (1b) and a second optical axis (13) of the second plate (1c), is 45 degrees, and a first reduction direction of the thickness of the first plate (1b) and a second reduction direction of the thickness of the second plate (1c) is opposite to each other.

Preferably, for example, as shown in FIG. 1, a third plate (1a) and a fourth plate (1d) are stuck on the first plate (1b) and the second plate (1c), respectively. That is, the depolarizer comprises two plates that are the first and second plates (1b and 1c ), three plates that are the first, second and third plates (1b, 1c and 1a), three plates that are the first, second and fourth plates (1b, 1c and 1d), or four plates that are the first, second, third and fourth plates (1b, 1c, 1a and 1d).

Preferably, each of the first plate, the second plate, the third plate and the fourth plate has a birefringence crystalline structure, and is made of any one of a crystal, a calcite, a mica and a magnesium fluoride.

As described above, as the number of plates decreases, it is possible to manufacture the depolarizer more easily and at a lower cost.

However, as the number of plates decreases such as three plates and two plates, an optical path length difference between a thick part and a thin part of the depolarizer increases. In other words, because an aberration increases, a spot diameter on an outgoing slit of a spectroscope using the depolarizer becomes large. As a result, a wavelength resolution of the spectroscope drops down. Accordingly, when the number of plates increases such as two plates, three plates and four plates, the spot diameter on the outgoing slit of the spectroscope becomes small. As a result, it is possible to improve the spectroscope in the wavelength resolution.

In accordance with another aspect of the present invention, a spectroscope comprises: the above-described depolarizer (for example, the depolarizer 1); and a spectroscopic device (diffraction grating 5) a dispersion direction of which intersects orthogonally with the first reduction direction of the thickness of the first plate (1b).

Accordingly, because the depolarizer and the spectroscopic device are positioned as described above, it is possible that a direction of an inclined surface of the depolarizer, with an incident light on the depolarizer and a direction (a groove direction in case the spectroscopic device is a diffraction grating 5) perpendicular to the dispersion direction of the spectroscopic device agree with each other.

Preferably, in the spectroscope of another aspect of the present invention, for example, as shown in FIG. 12, when the incident light passing through the depolarizer (1) is separated into first, second, third and fourth refracted lights (L7, L8, L9 and L10), any one pair of a pair of the first and third refracted lights (L7 and L9) and a pair of the second and fourth refracted lights (L8 and L10) is selected and used in a signal processing.

Preferably, in the spectroscope as described above, in order to select any of the first, second, third and fourth refracted lights (L7, L8, L9 and L10), for example, as shown in FIG. 10, an outgoing slit is used so that any one pair of the pair of the first and third refracted lights (L7 and L9) and the pair of the second and fourth refracted lights (L8 and L10) passes therethrough, and the other pair of the pair of the first and third refracted lights (L7 and L9) and the pair of the second and fourth refracted lights (L8 and L10) is cut off thereby.

Preferably, the above-described spectroscope is a multi-path spectroscope wherein a light passes through the spectroscopic device at n times, and uses the above-described depolarizer. Accordingly, it is possible to realize the spectroscope having a high wavelength resolution and a high wavelength accuracy.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1A is a perspective view, and FIG. 1B is an exploded perspective view, of a depolarizer 1 according to an embodiment of the present invention;

FIGS. 2A-F, 2A-P and 2A-S are a front view, a plan view, and a side view of a crystal plate 1a, FIGS. 2B-F, 2B-P and 2B-S are a front view, a plan view, and a side view of a crystal plate 1b, FIGS. 2C-F, 2C-P and 2C-S are a front view, a plan view, and a side view of a crystal plate 1c, and FIGS. 2D-F, 2D-P and 2D-S are a front view, a plan view, and a side view of a crystal plate 1d, of the depolarizer 1 according to the embodiment of the present invention;

FIG. 3 is a view showing a configuration of a spectroscope according to an embodiment of the present invention;

FIG. 4 is a view showing a configuration of a depolarizer 2 according to an earlier development;

FIG. 5 is a side view of the depolarizer 2, for explaining a polarization eliminating characteristic of the depolarizer 2 according to an earlier development;

FIG. 6 is a front view of an outgoing slit 7a of a spectroscope according to an earlier development;

FIG. 7 is a front view of the outgoing slit 7a of the spectroscope according to an earlier development;

FIG. 8 is a front view of an outgoing slit 7a of the spectroscope according to the embodiment of the present invention;

FIG. 9 is a front view of the outgoing slit 7a of the spectroscope according to the embodiment of the present invention;

FIG. 10 is a front view of an outgoing slit 7b of a spectroscope according to another embodiment of the present invention;

FIG. 11 is a side view of the depolarizer 2, for explaining a refractive characteristic of the depolarizer 2 according to an earlier development;

FIG. 12 is a side view of the depolarizer 1, for explaining a refractive characteristic of the depolarizer 1 according to the embodiment of the present invention;

FIGS. 13A to 13C are views of spectrums which are displayed on a spectrum display unit 10 shown in each of FIGS. 3 and 14;

FIG. 14 is a view showing a configuration of the spectroscope according to an earlier development; and

FIG. 15 is a perspective view of a diffraction grating 5 shown in each of FIGS. 3 and 14.

### PREFERRED EMBODIMENTS OF THE INVENTION

Hereinafter, a preferred embodiment of the present invention will be explained with reference to figures, as follows. The following description concerns to an embodiment of the present invention, and does not limit the present invention.

### First Embodiment

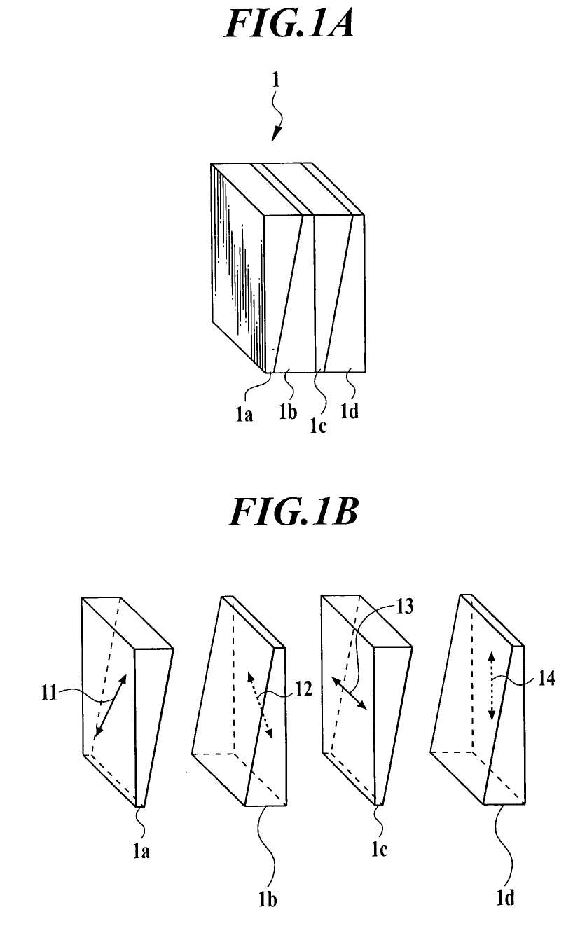

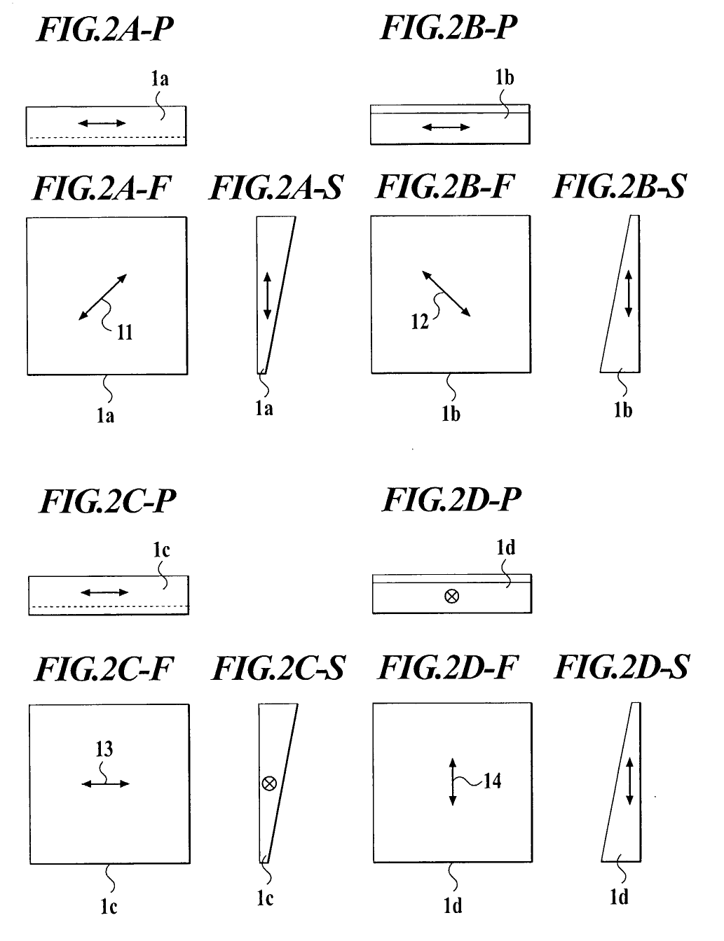

At first, a depolarizer according to a first embodiment of the present invention will be explained with reference to FIGS. 1A to 2D-S.

FIG. 1A is an external perspective view of a depolarizer 1, and FIG. 1B is an exploded perspective view of the depolarizer 1. FIGS. 2A-F, 2A-P and 2A-S are a front view, a plan view and a side view of a crystal plate 1a, FIGS. 2B-F, 2B-P and 2B-S are a front view, a plan view and a side view of a crystal plate 1b, FIGS. 2C-F, 2C-P and 2C-S are a front view, a plan view and a side view of a crystal plate 1c, and FIGS. 2D-F, 2D-P and 2D-S are a front view, a plan view and a side view of a crystal plate 1d, of the depolarizer 1.

A reference numeral 1 denotes a depolarizer. Reference numerals 1a, 1b, 1c and 1d denote crystal plates. Reference numerals 11, 12, 13 and 14 denote optical axes of the crystal plates 1a, 1b, 1c and 1d, respectively.

The depolarizer 1 comprises a crystal plate 1b as a first plate, a crystal plate 1c as a second plate, a crystal plate 1a as a third plate, and a crystal plate 1d as a fourth plate. The crystal plates 1a, 1b, 1c and 1d are stuck so that the depolarizer 1 has a constant thickness on the whole, as shown in FIG. 1A. The first, second, third and fourth plates can be made of a crystalline material having a birefringence, such as a calcite, a mica, a magnesium fluoride and so on, instead of a crystal. In addition, at least one of the crystal plates 1a and 1d may be omitted in the depolarizer 1. According to the first embodiment, the present invention will be basically explained in case the depolarizer 1 uses the crystal plates 1a, 1b, 1c and 1d.

As shown in FIGS. 1A to 2D-S, each of four crystal plates 1a, 1b, 1c and 1d is formed in a shape so that one surface thereof is inclined and a thickness thereof changes continuously.

As shown in FIGS. 1A and 1B, four crystal plates 1a, 1b, 1c and 1d are superposed so that each of the crystal plates 1a, 1b, 1c and 1d compensates the thickness thereof with one of the adjacent crystal plate. Therefore, the crystal plates 1a and 1b are stuck on each other, the crystal plates 1b and 1c are stuck on each other, and the crystal plates 1c and 1d are stuck on each other. Further, the reduction direction of the thickness of the crystal plate 1a is opposite to the reduction direction of the thickness of the crystal plate 1b. Similarly, the reduction direction of the thickness of the crystal plate 1b is opposite to the reduction direction of the thickness of the crystal plate 1c. The reduction direction of the thickness of the crystal plate 1c is opposite to the reduction direction of the thickness of the crystal plate 1d.

The thickness of the crystal plate 1a continuously changes in a direction of 45 deg. with the optical axis 11. The thickness of the crystal plate 1b continuously changes in a direction of 45 deg. with the optical axis 12. The thickness of the crystal plate 1c continuously changes in a direction perpendicular to the optical axis 13. The thickness of the crystal plate 1d continuously changes in a direction parallel to the optical axis 14.

As readily understood from the above description, the optical axis 11 of the crystal plate 1a and the optical axis 12 of the crystal plate 1b intersect orthogonally with each other. An angle between the optical axis 12 of the crystal plate 1b and the optical axis 13 of the crystal plate 1c is 45 deg. The optical axis 13 of the crystal plate 1c and the optical axis 14 of the crystal plate 1d intersect orthogonally with each other.

As described above, because the thickness of each of the crystal plates 1a, 1b, 1c and 1d continuously changes, the thickness or the transparent distance of each of the crystal plates 1a, 1b, 1c and 1d, through which the light passes, changes according to the position through which the light passes. Therefore, because the phase difference which is occurred in the crystal plates 1a, 1b, 1c and 1d changes according to the position through which the light passes, it is possible that depolarizer 1 converts the polarization state of the light to the state wherein a number of polarization states are mixed with respect to a space.

There does not occur the phase difference of the polarized light which oscillates in a direction parallel or perpendicular to the optical axis 12, in the crystal plate 1a and the crystal plate 1b. However, there occurs the phase difference of the polarized light in the crystal plate 1c and the crystal plate 1d, or in only the crystal plate 1c in case the crystal plate 1d is omitted from the depolarizer 1. As a result, the light has the state wherein a number of polarization states are mixed.

Further, there does not occur the phase difference of the polarized light which oscillates in a direction parallel or perpendicular to the optical axis 13, in the crystal plate 1c and the crystal plate 1d. However, there occurs the phase difference of the polarized light in the crystal plate 1a and the crystal plate 1b, or in only the crystal plate 1b in case the crystal plate 1a is omitted from the depolarizer 1. As a result, the light has the state wherein a number of polarization states are mixed.

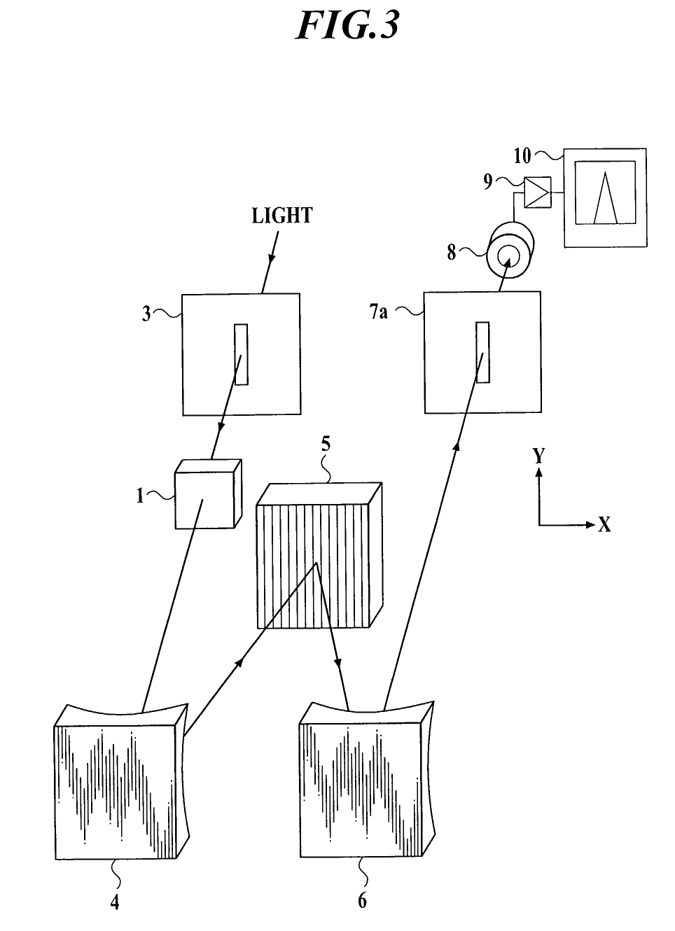

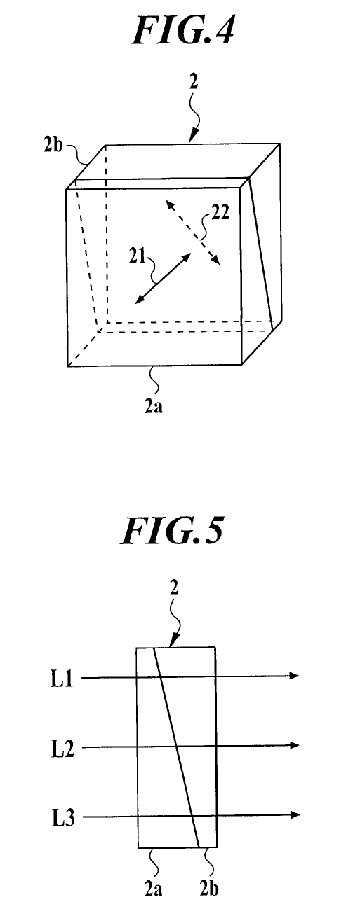

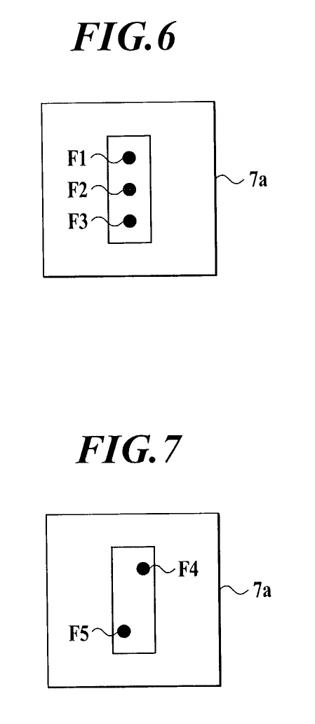

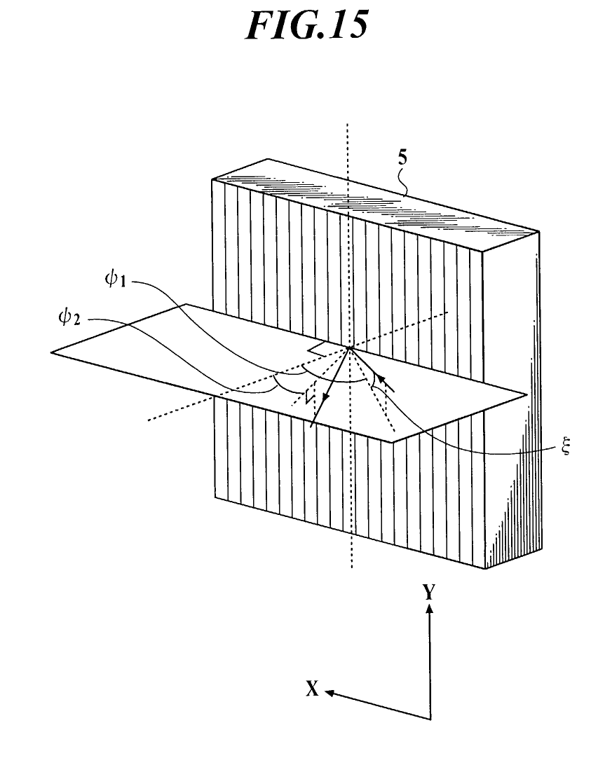

Next, a configuration of a spectroscope will be explained according to a first embodiment of the present invention with reference to FIG. 3. The present invention is not limited to a Czerny-Turner type of spectroscope shown in FIG. 3. The present invention can be applied to various types of spectroscopes such as a Littrow type of spectroscope and so on. The spectroscope according to the first embodiment uses the depolarizer 1 according to the above-described embodiment. Further, the spectroscope according to the first embodiment comprises parts similar to the spectroscope described with reference to FIG. 14, other than the depolarizer 1. That is, when the incident light on the spectroscope, passes through the incident slit 3 and the depolarizer 1, the light is reflected on the concave mirror 4, diffracted on the diffraction grating 5, and reflected on the concave mirror 6. Then, when the light passes through the outgoing slit 7a, the light is received by a light receiving unit 8, and processed by a signal processing unit 9. Therefore, the spectrum of the light is displayed on the spectrum display unit 10.

As shown in FIG. 3, the depolarizer 1 is positioned along an optical path after the incident slit 3. Further, the depolarizer 1 is positioned along the optical path so that the direction in which the thickness of the crystal plate 1b continuously changes and the dispersion direction of the diffraction grating 5 which is used as a spectroscopic device, intersect orthogonally with each other. As a result, the direction of the inclined surface formed on each of the crystal plates 1a, 1b, 1c and 1d is parallel to a groove direction of the diffraction grating 5. In addition, the outer surfaces of the crystal plates 1b and 1c, opposite to surfaces of the crystal plates 1b and 1c, which are stuck on each other, are directed in a direction inclined with the incident light. In other words, the outer surfaces of the crystal plates 1b and 1c are two inclined surfaces which are a demarcation surface between the crystal plate 1a (air in case the crystal plate 1a is omitted from the depolarizer 1) and the crystal plate 1b, and a demarcation surface between the crystal plate 1c and the crystal plate 1d (air in case the crystal plate 1d is omitted from the depolarizer 1).

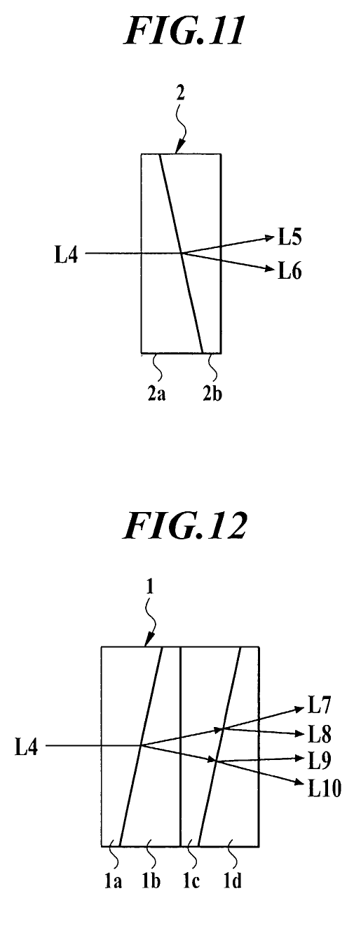

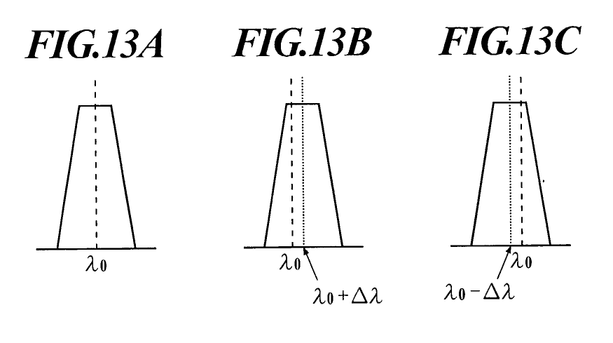

Next, a separation of light will be explained with reference to FIG. 12.

In the crystal plates 1a and 1b, because the optical axis 11 of the crystal plate 1a and the optical axis 12 of the crystal plate 1b intersect orthogonally with each other, the light oscillating in a direction parallel to the optical axis 11 of the crystal plate 1a oscillates in a direction perpendicular to the optical axis 12 of the crystal plate 1b. Further, the crystalline structure having the birefringence, has the refractive index to the light wave oscillating in a direction parallel to the optical axis and the refractive index to the light wave oscillating in a direction perpendicular to the optical axis, which are different from each other. Therefore, because the refractive indexes are different in both sides of the inclined surface which is the demarcation surface between the crystal plate 1a (air in case the crystal plate 1a is omitted from the depolarizer 1) and the crystal plate 1b, the light is refracted on the demarcation surface (inclined surface) between the crystal plate 1a and the crystal plate 1b. Furthermore, the refraction angle of the light component oscillating in the direction parallel to the optical axis 12 of the crystal plate 1b is different from the refraction angle of the light component oscillating in the direction perpendicular to the optical axis 12 of the crystal plate 1b. As a result, the light which is incident on the crystal plate 1b is separated into two refracted lights.

In the crystal plates 1c and 1d, because the optical axis 13 of the crystal plate 1c and the optical axis 14 of the crystal plate 1d intersect orthogonally with each other, the light oscillating in a direction parallel to the optical axis 13 of the crystal plate 1c oscillates in a direction perpendicular to the optical axis 14 of the crystal plate 1d. Further, because the refractive indexes are different in both sides of the inclined surface which is the demarcation surface between the crystal plate 1c and the crystal plate 1d (air in case the crystal plate 1d is omitted from the depolarizer 1), the light is refracted on the demarcation surface (inclined surface) between the crystal plate 1c and the crystal plate 1d. Furthermore, the refraction angle of the light component oscillating in the direction parallel to the optical axis 13 of the crystal plate 1c is different from the refraction angle of the light component oscillating in the direction perpendicular to the optical axis 13 of the crystal plate 1c. As a result, the two refracted lights which are incident on the crystal plate 1d are further separated into four refracted lights.

That is, as shown in FIG. 12, the incident light L4 is separated into four light rays L7, L8, L9 and L10.

$$\begin{matrix}{E}_{0} = \frac{1}{\sqrt{2}} ( \begin{matrix}cos φ & - sin φ \\ sin φ & cos φ\end{matrix} ) ( \begin{matrix}exp ( \frac{- i δ}{2} ) \\ exp ( \frac{δ}{2} )\end{matrix} ) exp [ i ( 2 π ft - {δ}_{0} ) ] & Eq . 9 \\ {P}_{0} = ( \begin{matrix}{cos}^{2} θ & cos θ \cdot sin θ \\ cos θ \cdot sin θ & {sin}^{2} θ\end{matrix} ) & Eq . 10 \\ G = ( \begin{matrix}α & 0 \\ 0 & β\end{matrix} ) & Eq . 11 \\ {E}_{1} = G \cdot {P}_{0 °} \cdot {P}_{45 °} \cdot {E}_{0} = \frac{α}{\sqrt{2}} ( \begin{matrix}cos φ \cdot cos \frac{δ}{2} - i \cdot sin φ \cdot sin \frac{δ}{2} \\ 0\end{matrix} ) exp [ i ( 2 π ft - {δ}_{0} ) ] & Eq . 12 \\ {E}_{2} = G \cdot {P}_{0 °} \cdot {P}_{- 45 °} \cdot {E}_{0} = - \frac{α}{\sqrt{2}} ( \begin{matrix}sin φ \cdot cos \frac{δ}{2} + i \cdot cos φ \cdot sin \frac{δ}{2} \\ 0\end{matrix} ) exp [ i ( 2 π ft - {δ}_{0} ) ] & Eq . 13 \\ {E}_{3} = G \cdot {P}_{- 90 °} \cdot {P}_{45 °} \cdot {E}_{0} = \frac{β}{\sqrt{2}} ( \begin{matrix}0 \\ cos φ \cdot cos \frac{δ}{2} - i \cdot sin φ \cdot sin \frac{δ}{2}\end{matrix} ) exp [ i ( 2 π ft - {δ}_{0} ) ] & Eq . 14 \\ {E}_{4} = G \cdot {P}_{- 90 °} \cdot {P}_{- 45 °} \cdot {E}_{0} = \frac{β}{\sqrt{2}} ( \begin{matrix}0 \\ sin φ \cdot cos \frac{δ}{2} - i \cdot cos φ \cdot sin \frac{δ}{2}\end{matrix} ) exp [ i ( 2 π ft - {δ}_{0} ) ] & Eq . 15 \\ {P}_{1} = {E}_{1} \cdot {E}_{1}^{*} = \frac{{α}^{2}}{2} ( {cos}^{2} φ \cdot {cos}^{2} \frac{δ}{2} + {sin}^{2} φ \cdot {sin}^{2} \frac{δ}{2} ) & Eq . 16 \\ {P}_{2} = {E}_{2} \cdot {E}_{2}^{*} = \frac{{α}^{2}}{2} ( {sin}^{2} φ \cdot {cos}^{2} \frac{δ}{2} + {cos}^{2} φ \cdot {sin}^{2} \frac{δ}{2} ) & Eq . 17 \\ {P}_{3} = {E}_{3} \cdot {E}_{3}^{*} = \frac{{β}^{2}}{2} ( {cos}^{2} φ \cdot {cos}^{2} \frac{δ}{2} + {sin}^{2} φ \cdot {sin}^{2} \frac{δ}{2} ) & Eq . 18 \\ {P}_{4} = {E}_{4} \cdot {E}_{4}^{*} = \frac{{β}^{2}}{2} ( {sin}^{2} φ \cdot {cos}^{2} \frac{δ}{2} + {cos}^{2} φ \cdot {sin}^{2} \frac{δ}{2} ) & Eq . 19 \\ {P}_{12} = {P}_{1} + {P}_{2} = \frac{{α}^{2}}{2} & Eq . 20 \\ {P}_{34} = {P}_{3} + {P}_{4} = \frac{{β}^{2}}{2} & Eq . 21 \\ P = {P}_{1} + {P}_{2} + {P}_{3} + {P}_{4} = \frac{1}{2} ( {α}^{2} + {β}^{2} ) & Eq . 22\end{matrix}$$

Using Jones vector notation representative of the polarization state of the light, it is possible to express an incident light E₀ in an arbitrary completely polarization state as shown in Equation (9). A first component of Equation (9) represents a scalar value of a X directional component, and a second component of Equation (9) represents a scalar value of a Y directional component. In Equation (9), “f” represents a frequency, “δ₀” represents an initial phase, “δ” represents a phase difference between the X direction component and the Y directional component, and “φ” represents an azimuth angle.

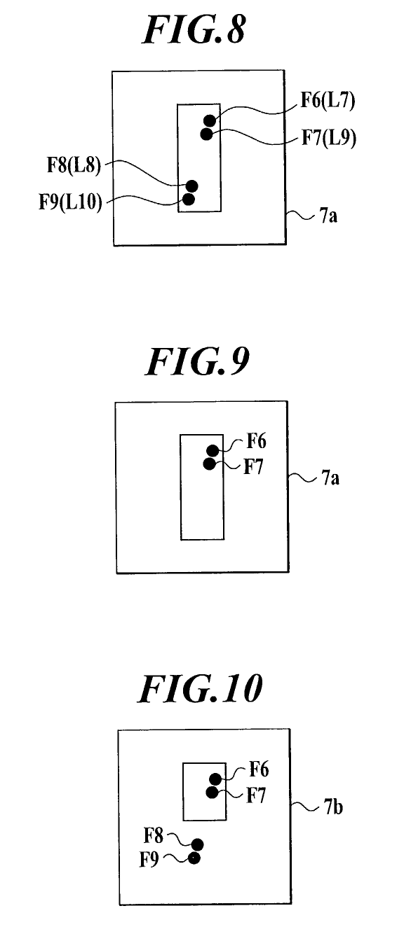

When the incident light L4 represented by Equation (9) passes through the depolarizer 1 which is positioned as shown in FIG. 3, the incident light is separated into four light rays L7, L8, L9 and L10 as shown in FIG. 12. Then, the four light rays L7, L8, L9 and L10 pass through the diffraction grating 5. Thereafter, the light rays L7, L8, L9 and L10 come into four focal points F6, F8, F7 and F9 on the outgoing slit 7a as shown in FIG. 8. At the time, the light rays L7, L8, L9 and L10 come into the focal points F6, F8, F7 and F9, respectively.

As the inclined angle of the inclined surface of the crystal plate 1b becomes small, the distance between the focal points F6 and F7 and the distance between the focal points F8 and F9 become small. Further, as the inclined angle of the inclined surface of the crystal plate 1c becomes small, the distance between F6 and F8 and the distance between F7 and f9 becomes small. When the inclined angle of the inclined surface of the crystal plate 1b is smaller than the inclined angle of the inclined surface of the crystal plate 1c, the distance between the focal points F6 and F7 and the distance between the focal points F8 and F9 becomes smaller than the distance between the focal points F6 and F8 and the distance between the focal points F7 and F9.

“E1” of Equation (12) represents the state of the light ray at the focal point F6, and “P1” of Equation (16) represents the power of the light ray at the focal point F6. “E2” of Equation (13) represents the state of the light ray at the focal point F7, and “P2” of Equation (17) represents the power of the light ray at the focal point F7. “E3” of Equation (14) represents the state of the light ray at the focal point F8, and “P3” of Equation (18) represents the power of the light ray at the focal point F8. “E4” of Equation (15) represents the state of the light ray at the focal point F9, and “P4” of Equation (19) represents the power of the light ray at the focal point F9. “P₇₄ ” of Equation (10) represents a partial polarizer of an azimuth angle θ. “G” of Equation (11) represents a diffraction grating whose diffractive efficiency is equal to α of the X directional component and whose diffractive efficiency is equal to β of the Y directional component. “*” represents a complex conjugate in each of Equations (16) to (19).

In general, the diffraction grating 5 has the diffractive efficiency which changes according to the oscillation direction of the light which is incident thereon.

As readily understood from Equations (16) to (19), when the diffractive efficiency in X direction is “α=1” and the diffractive efficiency in Y direction is “β=0”, only two focal points F6 and F7 are formed on the outgoing slit 7a as shown in FIG. 9. As a result, a pair of light rays L7 and L9 is selected from the pair of light rays L7 and L9 and a pair of light rays L8 and L10. On the other hand, when the diffractive efficiency in X direction is “α=0” and the diffractive efficiency in Y direction is “β=1”, because only two focal points F8 and F9 are formed on the outgoing slit 7a, the pair of light rays L8 and L10 is selected from the pair of light rays L7 and L9 and the pair of light rays L8 and L10.

As described above, when the inclined angle of the inclined surface of the crystal plate 1b is comparatively small, the distance between the foal point F6 and the focal point F7 is small on the outgoing slit 7a. As a result, it is possible to regard the focal point F6 and F7 as one focal point according to the characteristic of the spectroscope. As shown in Equation (20), the total of the power of the light ray at the focal point F6 and the power of the light ray at the focal point F7 is constant. That is, the light having the constant power comes into one focal point (spot) in the arbitrary polarization state.

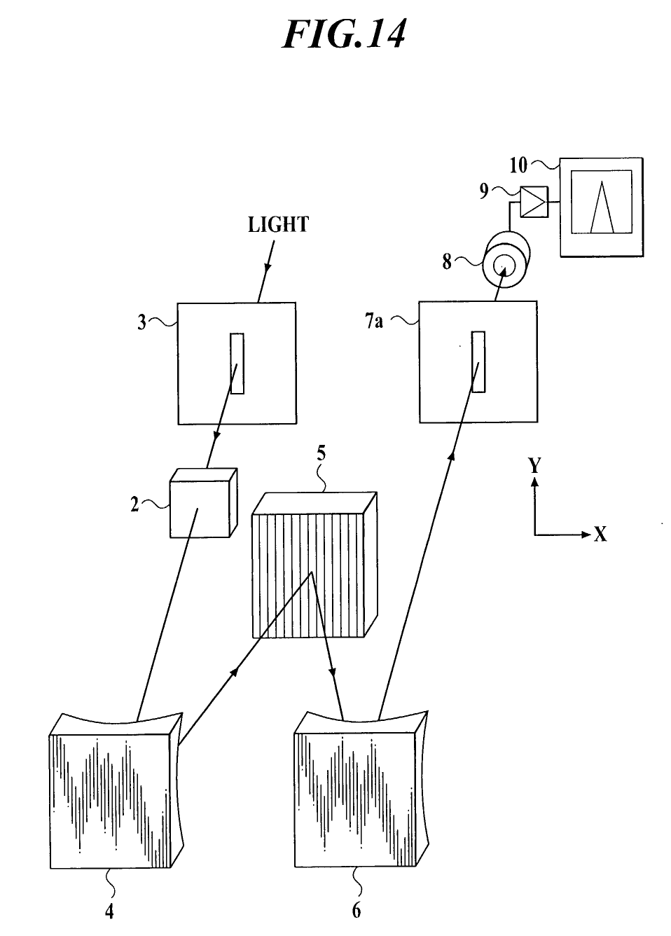

As a result, the spectrum as shown in FIG. 13B is displayed on the spectrum display unit 10 shown in FIG. 3. It is possible to obtain the spectrum having the stable central wavelength in the arbitrary polarization state. When the signal processing unit 9 shown in FIG. 3 has an adjusting function of always subtracting the constant Δλ from the measured central wavelength, it is possible to measure the spectrum having the true central wavelength.

In other words, it is possible to measure the spectrum having the true central wavelength with respect to the incident light in the arbitrary polarization state. As a result, it is possible to improve the spectroscope in the spectroscopic characteristic thereof, in comparison to the spectroscope which uses the conventional depolarizer.

### Second Embodiment

Next, a second embodiment of the present invention will be explained, as follows. Although the first embodiment has been explained with the outgoing slit 7a wherein the four light rays L7, L8, L9 and L10 pass through the focal points F6, F8, F7 and F9 as shown in FIGS. 8 and 9, the present second embodiment will be explained with an outgoing slit 7b as shown in FIG. 10 instead of the outgoing slit 7a.

The rectangular opening of the outgoing slit 7b is a slit that the rectangular opening of the outgoing slit 7a is shortened in the direction which has nothing to do with a wavelength selection. As shown in FIG. 10, the outgoing slit 7b cuts off two light rays L8 and L10 which travel to the focal points F8 and F9, respectively, and allows two light rays L7 and L9 which travel to the focal points F6 and F7 to pass therethrough. Therefore, because the two light rays L7 and L9 are selected as described above, it is unnecessary to relatively strengthen the powers of the light rays L7 and L9, and to relatively weaken the powers of the light rays L8 and L10, although it is necessary to relatively strengthen the powers of the light rays L7 and L9, and to relatively weaken the powers of the light rays L8 and L10 in the first embodiment.

Like the first embodiment, if the inclined angle of the inclined surface of the crystal plate 1b is small, the distance between the focal points F6 and F7 becomes small on the outgoing slit 7b. As a result, it is possible to regard the focal points F6 and F7 as one focal point according to the characteristic of the spectroscope. As understood from Equation (20), the total of the power of the light ray L7 at the focal point F6 and the power of the light ray L9 at the focal point F7 shown in FIG. 8, is constant. That is, it is possible to obtain one focal point (spot) at which the light has a constant power in the arbitrary polarization state.

As a result, the spectrum as shown in FIG. 13B is displayed on the spectrum display unit 10 shown in FIG. 3. It is possible to obtain the spectrum having the stable central wavelength in the arbitrary polarization state. When the signal processing unit 9 shown in FIG. 3 has an adjusting function of always subtracting the constant Δλ from the measured central wavelength, it is possible to measure the spectrum having the true central wavelength.

### Third Embodiment

Next, a third embodiment of the present invention will be explained, as follows. Although the first embodiment has been explained with the single path spectroscope which uses the diffraction grating shown in FIG. 3 at one time, the third embodiment will be explained with a multi path spectroscope which uses the diffraction grating at two or more times.

In other words, according to the first embodiment, the single path spectroscope is adopted so that the light passes through the diffraction grating which is the spectroscopic device, at one time. However, according to the third embodiment, the multi path spectroscope is adopted so that the light passes through the diffraction grating which is the spectroscopic device, at n times, and the depolarizer 1 is used in the spectroscope. As described above, when the depolarizer 1 is used in the multi path spectroscope, it is possible to obtain the following remarkable effects.

According to the third embodiment, “α” is replaced with “αⁿ”, and “β” is replaced with “βⁿ”, in Equations (11) to (22). As the number n that the light passes through the diffraction grating becomes great, the powers of the light rays at two focal points F6 and F7 become great relatively. Accordingly, it is easier to obtain only two focal points F6 and F7 as shown in FIG. 9. In other words, it is easier to select any of light rays. As a result, it is possible to measure the central wavelength of the spectrum at a higher accuracy. On the other hand, it is generally known that when the light passes through the diffraction grating at two or more times, the resolution of the wavelength is enhanced. As a result, when the depolarizer 1 of the present invention is used in the multi path spectroscope according to the present third embodiment, it is possible to realize the spectroscope having a high wavelength resolution and a high wavelength accuracy.

According to the present invention, the following effect will be indicated.

As described above, when the depolarizer of the present invention is used in the spectroscope, it is possible to measure the spectrum having the true central wavelength with respect to the incident light in the arbitrary polarization state, and to realize the spectroscope without a polarization dependence of the spectroscopic device. In other words, it is possible to improve the spectroscope in the spectroscopic characteristic, in comparison to the spectroscope which uses the conventional depolarizer.

The entire disclosure of Japanese Patent Application No. Tokugan 2001-196745 filed on Jun. 28, 2001 including specification, claims, drawings and summary are incorporated herein by reference in its entirety.

What is claimed is:

1. A depolarizer comprising:
a first plate a thickness of which continuously changes in a direction of 45 degrees with a first optical axis of the first plate; and
a second plate a thickness of which continuously changes, and which is stuck on the first plate;
wherein an angle between the first optical axis of the first plate and a second optical axis of the second plate, is 45 degrees, and
a first reduction direction of the thickness of the first plate and a second reduction direction of the thickness of the second plate is opposite to each other.

2. The depolarizer as claimed in claim 1, comprising:
a third plate a thickness of which continuously changes in a direction of 45 degrees with a third optical axis of the third plate, and which is stuck on the first plate;
wherein the first optical axis of the first plate and the third optical axis of the third plate intersect orthogonally with each other, and
the first reduction direction of the thickness of the first plate and a third reduction direction of the thickness of the third plate is opposite to each other.

3. The depolarizer as claimed in claim 1, comprising:
a fourth plate a thickness of which continuously changes, and which is stuck on the second plate;
wherein the second optical axis of the second plate and a fourth optical axis of the fourth plate intersect orthogonally with each other, and
the second reduction direction of the thickness of the second plate and a fourth reduction direction of the thickness of the fourth plate is opposite to each other.

4. The depolarizer as claimed in claim 2, comprising:
a fourth plate a thickness of which continuously changes, and which is stuck on the second plate;
wherein the second optical axis of the second plate and a fourth optical axis of the fourth plate intersect orthogonally with each other, and
the second reduction direction of the thickness of the second plate and a fourth reduction direction of the thickness of the fourth plate is opposite to each other.

5. The depolarizer as claimed in claim 1, wherein each of the first plate and the second plate is made of any one of a crystal, a calcite, a mica and a magnesium fluoride.

6. The depolarizer as claimed in claim 2, wherein the third plate is made of any one of a crystal, a calcite, a mica and a magnesium fluoride.

7. The depolarizer as claimed in claim 3, wherein the fourth plate is made of any one of a crystal, a calcite, a mica and a magnesium fluoride.

8. A spectroscope comprising:
a depolarizer comprising: a first plate a thickness of which continuously changes in a direction of 45 degrees with a first optical axis of the first plate; and a second plate a thickness of which continuously changes, and which is stuck on the first plate; wherein an angle between the first optical axis of the first plate and a second optical axis of the second plate, is 45 degrees, and a first reduction direction of the thickness of the first plate and a second reduction direction of the thickness of the second plate is opposite to each other; and
a spectroscopic device a dispersion direction of which intersects orthogonally with the first reduction direction of the thickness of the first plate.

9. The spectroscope as claimed in claim 8,
wherein the depolarizer comprising: a third plate a thickness of which continuously changes in a direction of 45 degrees with a third optical axis of the third plate, and which is stuck on the first plate,
the first optical axis of the first plate and the third optical axis of the third plate intersect orthogonally with each other, and
the first reduction direction of the thickness of the first plate and a third reduction direction of the thickness of the third plate is opposite to each other.

10. The spectroscope as claimed in claim 8,
wherein the depolarizer comprising: a fourth plate a thickness of which continuously changes, and which is stuck on the second plate,
the second optical axis of the second plate and a fourth optical axis of the fourth plate intersect orthogonally with each other, and
the second reduction direction of the thickness of the second plate and a fourth reduction direction of the thickness of the fourth plate is opposite to each other.

11. The spectroscope as claimed in claim 9,
wherein the depolarizer comprising: a fourth plate a thickness of which continuously changes, and which is stuck on the second plate,
the second optical axis of the second plate and a fourth optical axis of the fourth plate intersect orthogonally with each other, and
the second reduction direction of the thickness of the second plate and a fourth reduction direction of the thickness of the fourth plate is opposite to each other.

12. The spectroscope as claimed in claim 8, wherein when a first external surface opposite to a first stuck surface of the first plate, which is stuck on a second stuck surface of the second plate, and a second external surface opposite to the second stuck surface, are inclined to an incident light, the incident light is refracted on the first external surface of the first plate and separated into a primary first refracted light and a primary second refracted light, the primary first refracted light is refracted on the second external surface of the second plate and separated into a secondary first refracted light and a secondary second refracted light, and the primary second refracted light is refracted on the second external surface of the second plate and separated into a secondary third refracted light and a secondary fourth refracted light, a focal point of the secondary first refracted light and a focal point of the secondary third refracted light are closer to each other than the focal point of the secondary first refracted light and a focal point of the secondary second refracted light, on an outgoing slit for wavelength-selecting any of the secondary first, second, third and fourth refracted lights, and any one pair of a pair of the secondary first refracted light and the secondary third refracted light and a pair of the secondary second refracted light and the secondary fourth refracted light is selected.

13. The spectroscope as claimed in claim 12, wherein any one pair of the pair of the secondary first refracted light and the secondary third refracted light and the pair of the secondary second refracted light and the secondary fourth refracted light passes through an opening of the outgoing slit, and the other pair of the pair of the secondary first refracted light and the secondary third refracted light and the pair of the secondary second refracted light and the secondary fourth refracted light is cut off by the outgoing slit.

14. The spectroscope as claimed in claim 8, wherein a light passes through the spectroscopic device at n times.
